(19) United States
(12) Patent Application Publication
(10) Pub. No.: US 2025/0054374 A1
(43) Pub. Date: Feb. 13, 2025

(54) System and Method for a Crane Arcade Game

(71) Applicant: UNIS Technology Ltd., Markham (CA)

(72) Inventor: Tan Chee Wooi, Markham (CA)

(21) Appl. No.: 18/930,972

(22) Filed: Oct. 29, 2024

Related U.S. Application Data
(62) Division of application No. 18/741,642, filed on Jun. 12, 2024.
(60) Provisional application No. 63/495,115, filed on Apr. 9, 2023.

(51) Int. Cl. G07F 17/32

(52) U.S. Cl. CPC G07F 17/3297; G07F 17/3213; G07F 17/3216; G07F 17/3227; G07F 17/3253; G07F 17/3267; G07F 17/3209

(57) ABSTRACT

A crane arcade game system, comprising an LCD component, a cabinet, an external game control panel, an internal game module, a mechanical crane, and a prize chute having networking ability to interact with other crane arcade machine.

### INCORPORATION BY REFERENCE

This application is a divisional application of and claims the benefit of priority under 35 U.S.C. 121 to the U.S. Non-provisional application Ser. No. 18/741,642, entitled “A System and Method for a Crane Arcade Game,” filed on Jun. 12, 2024, which claims the benefit of priority under 35 U.S.C. 119 (e) to the filing date of U.S. Provisional application No. 63/495,115, entitled “Method and Apparatus for an Arcade Game,” which was filed on Apr. 9, 2023, and which are incorporated herein by reference in their entirety.

### BACKGROUND OF THE INVENTION

Arcade game machines have come a long way since their early days. In the beginning, arcade games were simple and often used electromechanical technology. However, as technology has advanced, arcade games have become more complex and immersive. Today, arcade games feature state-of-the-art graphics, sound, and gameplay.

One of the most significant advances in arcade game technology has been the development of microprocessors. Microprocessors allow arcade games to be much more complex and interactive than they were in the past. This is because microprocessors can be programmed to perform complex calculations and operations. As a result, arcade games can now feature realistic graphics, complex physics, and challenging gameplay.

Another major advance in arcade game technology has been the development of high-definition displays. High-definition displays allow arcade games to produce stunning visuals and impossible graphics on older machines. This is because high-resolution displays can display more pixels than older displays. As a result, arcade games can now look more realistic and immersive than ever before and more enjoyable for players.

In addition to microprocessors and high-resolution displays, arcade game technology has also benefited from advances in sound technology. Sound technology allows arcade games to produce realistic sound effects and music, helping to create a more immersive experience for players.

Yet other advances in networking technology, wired or wireless, have also prompted game inventors to incorporate those technological advances into their game design. The result is gameplay that enables multiple players to compete against each other either directly through role-playing or indirectly by comparing game stats.

Since the 1980s, when crane machines surged in popularity worldwide and stuffed animal crane machines became a global phenomenon, technological advancements have led to more complex crane movements and prize presentations, making the game even more engaging. Presently, crane machines can be found in many commercial establishments, such as arcades, malls, and even restaurants.

However, up to recently, the crane machine was a standalone machine with one crane for one player at a time. It was unsuitable for a group of friends or a party or event when multiple players wanted to enjoy the game and have fun together. Thus, it is desirable to have a new crane arcade game that allows for group games.

This invention will disclose a novel crane arcade game and its design. Its networking capability will push crane arcade game design further so that multiple players can participate, compete, and have fun together. Furthermore, this invention also utilizes the latest high-definition LCD technology to improve the crane arcade game.

### SUMMARY OF THE INVENTION

In one aspect of the invention, a crane arcade game system, comprising an LCD component, a cabinet, an external game control panel, an internal game module, a mechanical crane, a prize chute; Wherein the LCD component is tiltable and further comprises an LCD and a mount that comprises two mirroring right and left hinges and an LCD frame; wherein the right hinge further comprises a top and bottom mounting plates joined together by a shank bolt on their short sides; wherein the bottom mounting plate is attached to a top of the cabinet and the top mounting plate is attached to a back of the LCD frame; wherein the LCD is attached to the LCD frame; Wherein the cabinet comprises top and bottom halves; wherein the top half comprises a front, left, and right transparent side; wherein the top half further comprises a top, back, and bottom side; wherein the top half further comprises shelves for displaying prize samples; wherein the external game control panel further comprises an input device, an input button, and a joystick; wherein the internal game module operable to move the mechanical crane in response to the input device, the input button, and the joystick; wherein the mechanical crane is mounted on a rail that is attached to a ceiling of the top half running across a breadth of the ceiling; wherein the mechanical crane is connected to and controlled by the internal game module to grab a prize positioned at a bottom of the top half or to release a prize down the prize chute. In one embodiment, The crane arcade game system of claim 1 further comprises a mobile user interface (UI) that in turn comprises a management module that in turn comprises a series of screens; wherein the series of screens comprises a login screen, a game location selection screen, and an operational status screen; Wherein the operational status screen comprises a collection of icons that in turn comprises colored online-status icons, colored offline-status icons, and colored win-status icons. In one aspect of the invention, a method of conducting a crane arcade game system comprising: Providing an LCD component, a cabinet, an external game control panel, an internal game module, a mechanical crane, a prize chute; Wherein the LCD component is tiltable and further comprises an LCD and a mount that comprises two mirroring right and left hinges and an LCD frame; wherein the right hinge further comprises a top and bottom mounting plates joined together by a shank bolt on their short sides; wherein the bottom mounting plate is attached to a top of the cabinet and the top mounting plate is attached to a back of the LCD frame; wherein the LCD is attached to the LCD frame; Wherein the cabinet comprises top and bottom halves; wherein the top half comprises a front, left, and right transparent side; wherein the top half further comprises a top, back, and bottom side; wherein the top half further comprises shelves for displaying prize samples; wherein the external game control panel further comprises an input device, an input button, and a joystick; wherein the internal game module operable to move the mechanical crane in response to the input device, the input button, and the joystick; wherein the mechanical crane is mounted on a rail that is attached to a ceiling of the top half running across a breadth of the ceiling; wherein the mechanical crane is connected to and controlled by the internal game module to grab a prize positioned at a bottom of the top half or to release a prize down the prize chute. In one embodiment, the method of conducting a crane arcade game system of claim 3 further comprises providing a mobile user interface (UI) that in turn comprises a management module that in turn comprises a series of screens; wherein the series of screens comprises a login screen, a game location selection screen, and an operational status screen; Wherein the operational status screen comprises a collection of icons that in turn comprises colored online-status icons, colored offline-status icons, and colored win-status icons.

In yet another aspect of the invention, a crane arcade game apparatus comprised a cabinet, an external game control panel, a mechanical crane, and a monitor display located on top of the cabinet. In one embodiment, the monitor display is comprised of an adjustable module for tilting the monitor based on a preferred angle. In one embodiment, the monitor is an LCD monitor. In one embodiment, the length of the LCD monitor is of the same length of the cabinet. In one embodiment, the preferred angle is selected from the group consisting of 1-degree tilt, 2-degree tilt, 3-degree tilt, 4-degree tilt, 5-degree tilt, and a combination thereof.

One aspect of the invention is a crane arcade game apparatus with a monitor comprising a networking module to allow networking for remote administration by an administrative user. In one embodiment, the networking module provides a remote user interface for the administrative user to administer one or more contents on the monitor. In one embodiment, the networking module provides access to the administrative user via remote connection technology selected from a group consisting of Wi-Fi technology and Bluetooth technology. In one embodiment, the networking module networks a second crane arcade game apparatus and allows the user to administer the contents on the monitors of both apparatus. In one embodiment, the networking module networks a variable number of crane arcade game apparatuses, allowing users to administer the contents on the apparatuses' monitors. In one embodiment, the apparatus comprises at least one LED component, and the networking module allows the user to administer pre-determined lighting patterns on the LED component. In one embodiment, the networking module networks at least a second crane arcade game apparatus, allowing the user to administer pre-determined lighting patterns on the LED components. In one embodiment, the contents are selected from a group consisting of computer graphics, literal characters, pictures, and a combination thereof.

In yet another aspect of the invention, the network crane arcade game system comprises several networked arcade crane apparatuses and several users wherein the users play one or more network games on the networked arcade crane apparatuses. In one embodiment, the network game determines a winner amongst the users based on the highest number of inputs entered by the users. In one embodiment, the network game determines a winner amongst the users based on the highest number of inputs entered by the users. In one embodiment, the network game determines a winner amongst the users based on the number of prizes crane picked by the users.

### OBJECT OF THE INVENTION

This invention aims to provide a networked crane arcade game machine with enticing gameplay, an LCD display, sound, and color lights.

The object of this is to provide a modern arcade game machine with a flexible LCD display.

### FIELD OF THE INVENTION

This invention relates to arcade game machine technology and design, particularly to networking cranes/crane arcade game machines.

### BRIEF DESCRIPTION OF THE FIGURES

FIG. 1 depicts an embodiment of the current invention's arcade game machine with its dynamic LCD display, its transparent display, its control panel, its ornamental neon strips and its prize chute.

FIG. 2 depicts an exemplary network design of the current invention where multiple crane arcade machines are networked together.

FIG. 3 depicts another exemplary network design of the current invention, where multiple crane arcade machines and an LED jumbotron are networked together.

FIG. 4 depicts another embodiment of the current invention's arcade game machine with components similar to that shown in FIG. 1 but with a dynamic LCD.

FIG. 5 depicts an embodiment of the current invention's arcade game machine, which has a tiltable LCD.

FIG. 6 depicts an embodiment of the current invention's LCD mount that is tiltable.

FIG. 7 depicts an embodiment of the current invention's mobile game management software.

FIG. 8 depicts an exemplary screen of the Welcome settings screen of the current invention's game management software.

FIG. 9 depicts an exemplary screen of the Party Menu settings screen of the current invention's game management software.

FIG. 10 depicts an exemplary lighting settings screen of the current invention's game management software.

FIG. 11 illustrates the games that the current invention can be configured to provide.

FIG. 12 illustrates another embodiment of current invention can be configured to provide.

### DETAILED DESCRIPTION

The present disclosure may be implemented in various configurations for gaming machines or a gaming system, including but not limited to (1) a dedicated gaming machine or gaming system wherein the computerized instructions for controlling any games (that are provided by the gaming machine or gaming system) are provided with the gaming machine or gaming system before delivery to a gaming establishment; and (2) a changeable gaming machine or gaming system wherein the computerized instructions for controlling any games (that are provided by the gaming machine or gaming system) are downloadable to the gaming machine or gaming system through a data network (such as the Internet) after the gaming machine or gaming system is in a gaming establishment.

In one embodiment, the computerized instructions for controlling games are executed by at least one central server, central controller, or remote host. In such a “thin client” embodiment, the central server remotely controls any games (or other suitable interfaces), and the gaming device is utilized to display such games (or suitable interfaces) and receive one or more inputs or commands from a player.

In another embodiment, the computerized instructions for controlling games are communicated from the central server, central controller, or remote host to a gaming device's local processor and memory devices. In such a “thick client” embodiment, the gaming device's local processor executes the communicated computerized instructions to control any games (or other suitable interfaces) provided to a player.

In one embodiment, one or more gaming devices in a gaming system may be thin client gaming devices, and one or more gaming devices in the gaming system may be thick. In another embodiment, certain functions of the gaming device are implemented in a thin client environment and certain other functions of the gaming device are implemented in a thick client environment. In one such embodiment, computerized instructions for controlling any base or primary wagering games are communicated from the central server to the gaming device in a thick client configuration, and a central server executes computerized instructions for controlling any bonus games or functions in a thin client configuration.

A crane or crane arcade machine is a game of skill and chance. The goal of the game is to use the crane to grab a prize and move it over the prize chute so that it drops out of the machine. However, the crane's grip strength can be weak, and the prizes can be awkwardly positioned, making it difficult to win a prize. This is part of what makes the game so challenging and fun.

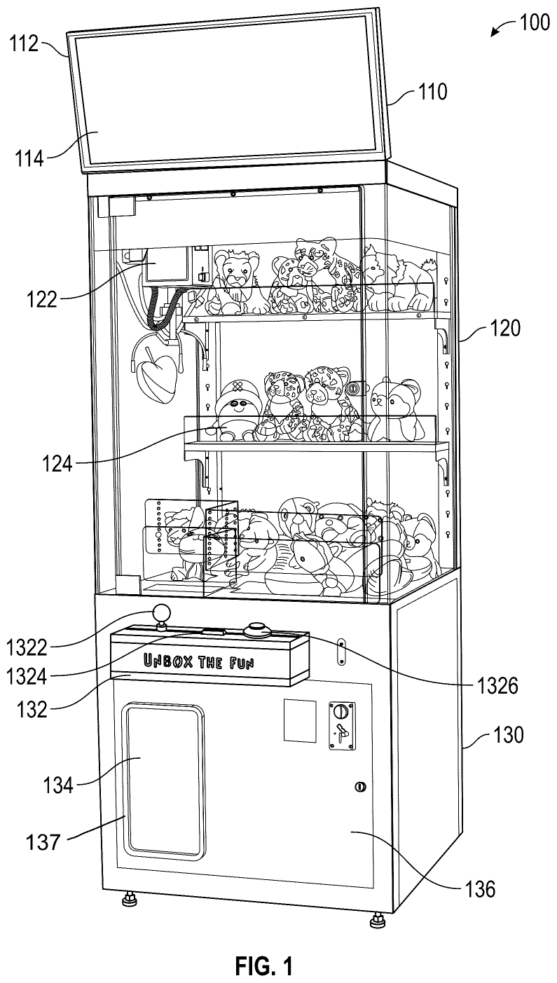

FIG. 1 discloses an embodiment 100 of the current invention that comprises game title LCD component 110 and a cabinet that comprises a top half 120 and a bottom half 130. In this embodiment, the LCD component 110 is tilted forward at an angle and comprises a mount 112 and the LCD 114. The LCD is mounted on the mount. The mount is mounted on the top of the top half 120. The mount comprises hinges that allow the LCD component to be tiltable. The mount can tilt from 0 to 270 degrees. The top half 120 comprises 3 transparent sides: front, left, and right. It also comprises a top, back, and bottom side. The top half further comprises a mechanical crane 122 mounted on a rail that is, in turn, attached to the top half's ceiling and running across the breadth thereof. The mechanical crane is connected to and controlled by the game controller component. During a game, the crane is caused to move across forth and back and drop down to the bottom of the top half 120 to grab prizes there. The top half further comprises shelves 124 for displaying prize samples.

The bottom half 130 is closed off from the public and players except a control panel 132 located on the front thereof and comprises control inputs, and a prize chute 134 that is a small opening, accessible from the front side thereof, about the bottom thereof, where the prizes fall out if a player successfully grabs one. The bottom half further comprises a locked cabinet door 136 that secures the internal components of the crane machine. Only the management of the game establishment has access to the internal components to change, update, or fix the game. In one embodiment, LED light 137 adorns the surrounds of the chute 134. The user can control its light or color patterns via remote access.

The control panel 132 further comprises a joystick 1322 and control input buttons. In one embodiment, one of the control inputs is a coin slot 1324 for depositing the game fee. In another embodiment, one of the control inputs is a crane-grabbing button 1326 that causes the mechanical crane to be lowered from the ceiling rail to the bottom of the top half to grab a prize and lift it to the ceiling rail. It is contemplated that a similar function of dropping the grabbed prize into the prize chute so that the player can take his prize can be implemented and executed using the same crane-grabbing button. In yet another embodiment, the control panel further comprises a display screen showing the player's remaining time and/or ticket count.

The player uses the joystick 1322 to control and move the crane. The joystick can be used to move the crane up/down, left/right, and forward/backward. By moving the joystick in different directions, the player can maneuver the crane into position to grab a prize.

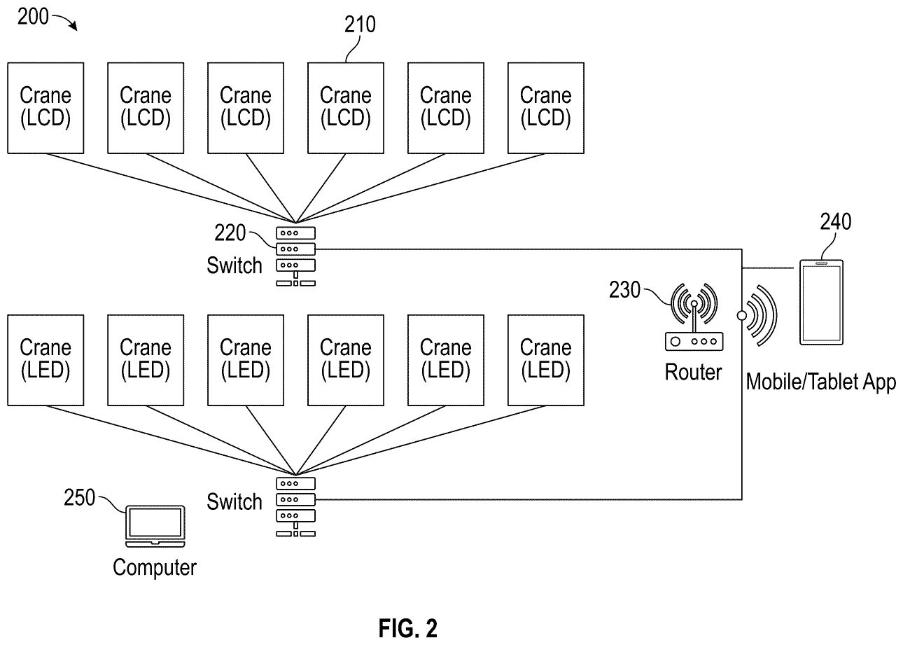

FIG. 2 discloses an exemplary network 200 of the current invention where multiple units of the current invention are connected via network switches and routers. The Network 200 comprises multiple crane arcade game unit 210 that connect to a switch 220 or multiple switches 220 depending on the number of the connected game units, their placement in the game establishment, or the game establishment's network design. The Switch 220, in turn, connects to router 230 or multiple routers. The router 230 allows the crane arcade game network to connect to a wider network that comprises mobile devices 240 or computers 250. The routers' connectivity is configurable per the game establishment's desire.

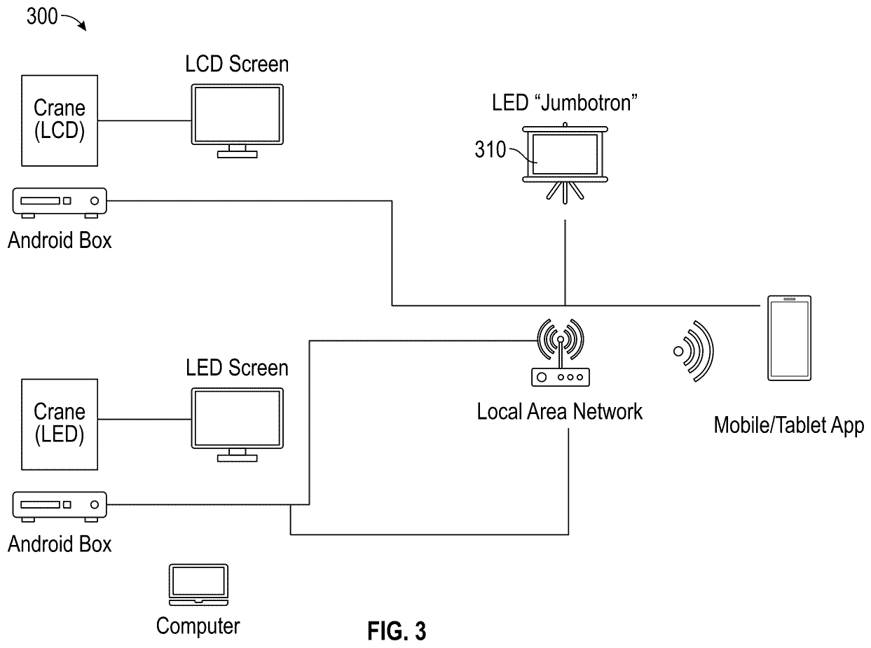

FIG. 3 discloses another exemplary network 300 of the current invention where an LED jumbotron 310, i.e., video and LCD walls, is incorporated into the setup. As disclosed in FIG. 1, each crane arcade game machine has an LCD on its top, controlled by the internal game control module to display conditional graphics comprising pre-configured, conditional gameplay, game event, and game tournament graphics. Also, the ability to display includes pictures of users or groups of users to celebrate occasions or to announce winners of crane networking games. All LCDs can independently display conditional graphics. They can also be a unit of a group of the crane arcade game machines and display a whole conditional graphic in synchronization with the other units in the group or display a part of the graphic, i.e., in effect, the group's LCDs create a jumbotron. In addition to the individual LCD of each machine, the current invention also allows a standalone jumbotron to be connected to and controlled by the crane arcade game control module to display conditional graphics grandiosely and thus entice game players.

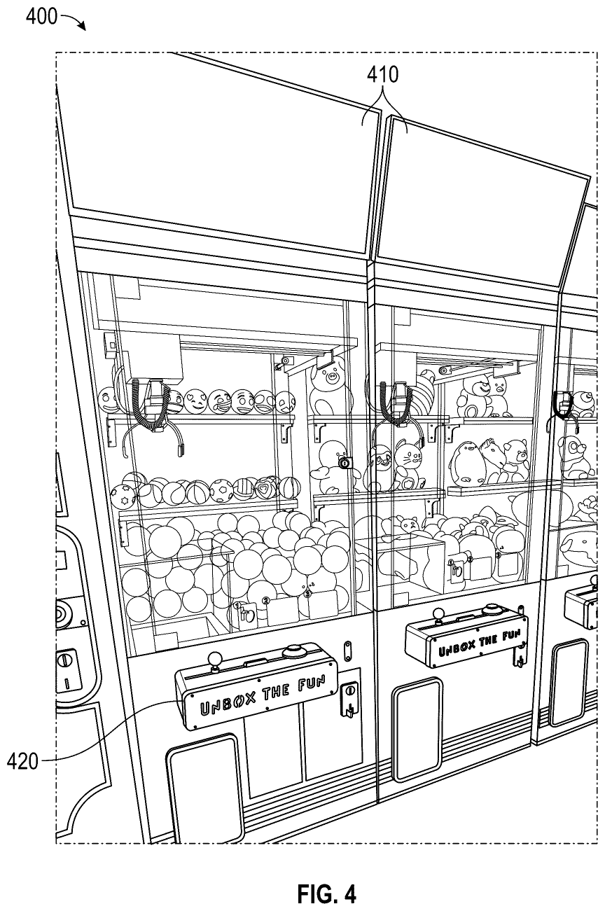

FIG. 4 discloses another embodiment 400 of the present invention where two machines are networked together to let two players play the game simultaneously. The networking is manifested by the LCDs 410 displaying the game title across them, although the LCDs are physically separate. The LCDs are mounted flush with the front of the machine and are tiltable. As shown, one is tilted forward more than the other. In this embodiment, the cabinets are ornamented with neon light strips 420 around the top edge of the cabinet, around the perimeter of the control panel, and around the perimeter of the front panel of the cabinet's bottom half to entice players to the game. It is contemplated that the two machines can be placed apart but work together as they are side by side.

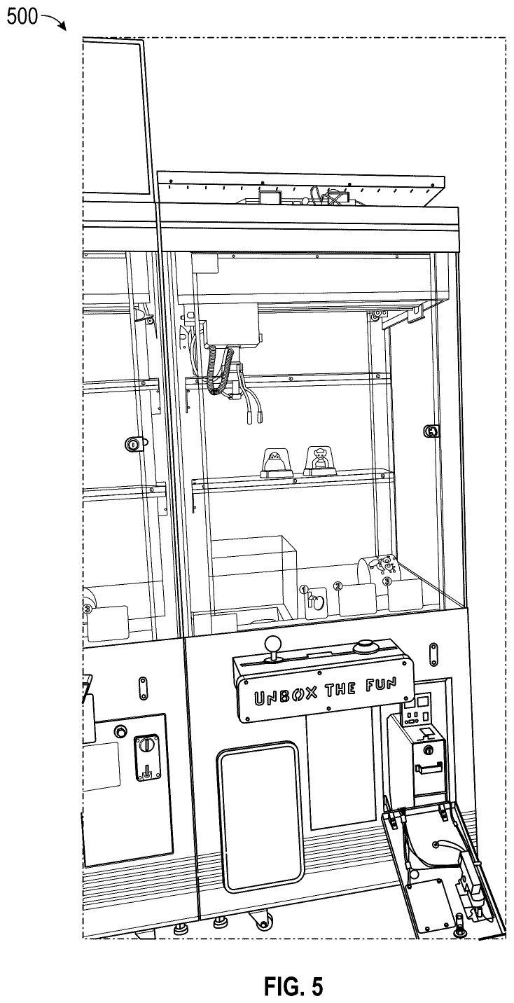

FIG. 5 discloses another embodiment 500 of the present invention where the bottom half's locked door, as disclosed in FIG. 1, is unlocked to show the internal components.

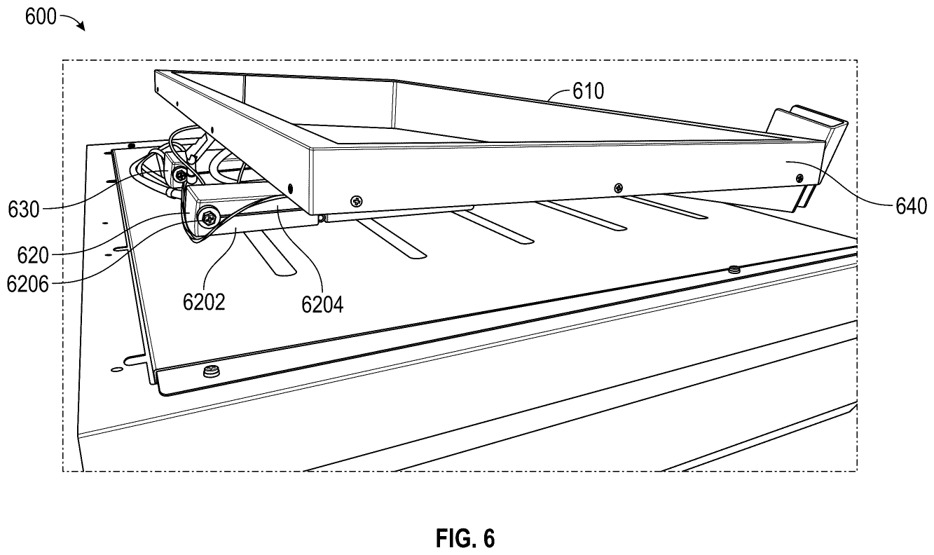

FIG. 6 discloses another embodiment 600 of the present invention where the LCD mount 610 is shown closeup. The LCD mount comprises two mirroring right and left hinges, 620 and 630, and an LCD frame, 640. The hinge 620 further comprises two mounting plates, 6202 and 6204, joined together by a shank bolt 6206 on their short sides. Plate 6202 is attached to the top of the machine cabinet and runs from front to back. The plate 6204 is attached to the back of the LCD frame 640, running from the bottom to the top. As the plate 6204 rotates on the shank bolt relative to the plate 6202, the LCD frame 640 is tilted. The mounting positions on the top of the cabinet and the back of the LCD frame are adjustable to the specifications of the game establishment, from a 1-degree tilt to as much as 90-degree tilt, facing downward as necessary. Generally, the best mode will be between 1 to 5 degrees titled downward. The frame 6204 comprises a variety of attachment means, such as an LCD that can be attached to the frame.

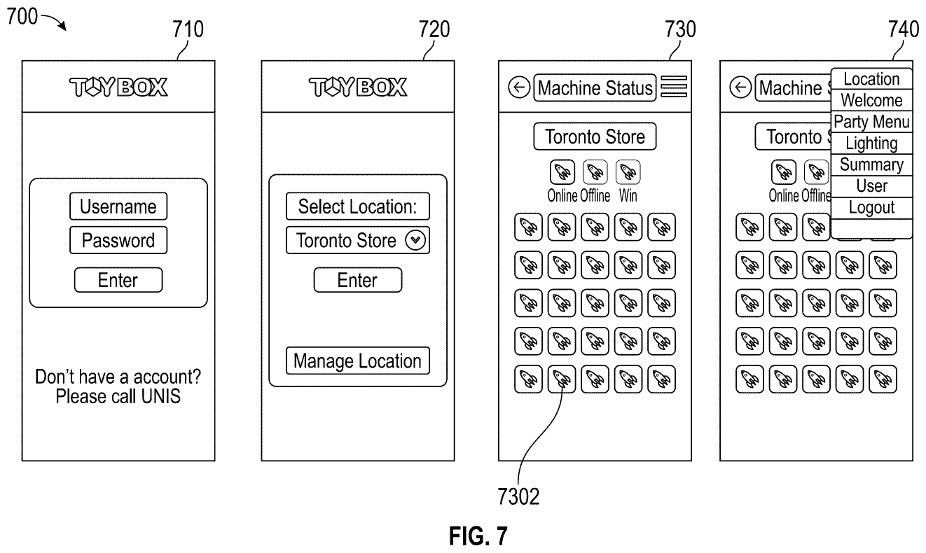

FIG. 7 discloses an embodiment 700 of the current invention's mobile user interface (UI). The mobile UI comprises the management module of the crane arcade game machine, which in turn comprises multiple screens. The login screen 710 is the first screen of the UI in which the game establishment, a.k.a., game operator, enters its pre-set username and password to access the settings of the machines. Following a valid authentication, a game location selection screen 720 is shown. The operator has to select a game location to access its specific settings. This screen 720 also allows the operator to add, delete, or manage the different locations. Once a location is selected, all connected crane arcade machines are listed on the next screen 730, the Machine Status screen. Each machine is represented by a customizable icon 7302. This icon has three status colors representing the three operating statuses of the machine: pink or red for Online status, gray or black for Offline status, and yellow or orange for Win status.

The UI 700 further comprises a pulldown menu of 740, which includes location, welcome, party menu, lighting, summary, user, and login options. The Location allows the operator to add or remove a location, similar to the “Manage Location” button on screen 720. The Summary option lets the operator view a summary report of all the crane machines connected to the location. The User option allows the operator to change the user password. The Administrator user can also add or remove authorized staff accounts.

The menu 740 further comprises individual machine-specific setting options: Welcome graphic, Party Menu event settings, and Lighting. The Welcome option lets the operator configure the welcome graphic to be displayed on the LCD, the colors and patterns display of the LED neon light strips, and the background music. The Party Menu option allows the operator to set different game events' settings, such as settings for holiday or birthday parties, and/or designate specific machines for the events. The operator can give free game credits or on-screen greetings customized with the player's name. The operator can also incorporate the player's photo into the welcome greeting graphic. The Lighting option allows the operator to change the colors and display patterns of the ornamental LED strips on the game machine.

The UI 700 further comprises a Mini Games and Tournaments screen that allows the operator to configure a specific group of crane machines for a tournament. This screen allows configuration for a specific subgroup, all the crane machines at one location, or subgroups of machines at multiple locations. These settings can be changed at any time before the tournament's conclusion.

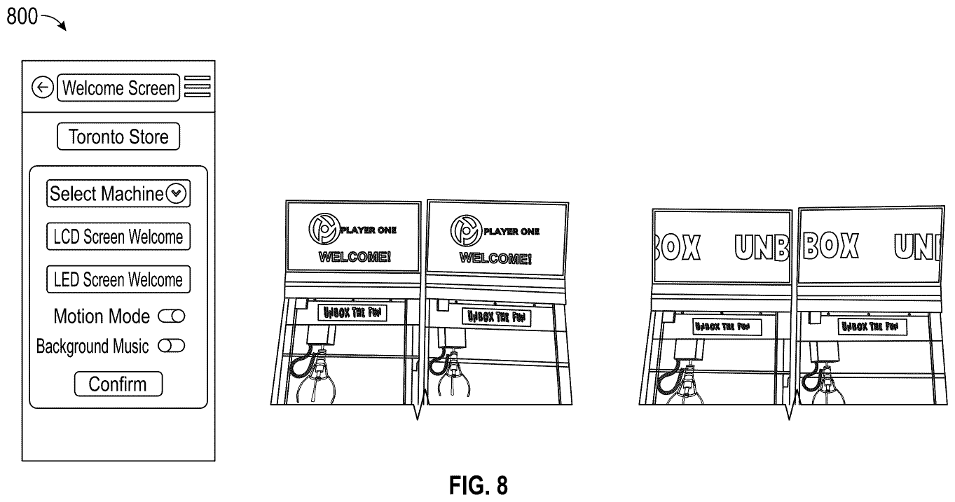

FIG. 8 illustrates an exemplary embodiment 800 of the welcome setting screen of the management UI. As disclosed above, this Welcome screen comprises an option to select a machine whose welcome graphic is being set. The screen also comprises textboxes for entering text messages, an ON/OFF button for setting the motion mode, and an ON/OFF button for setting the background music.

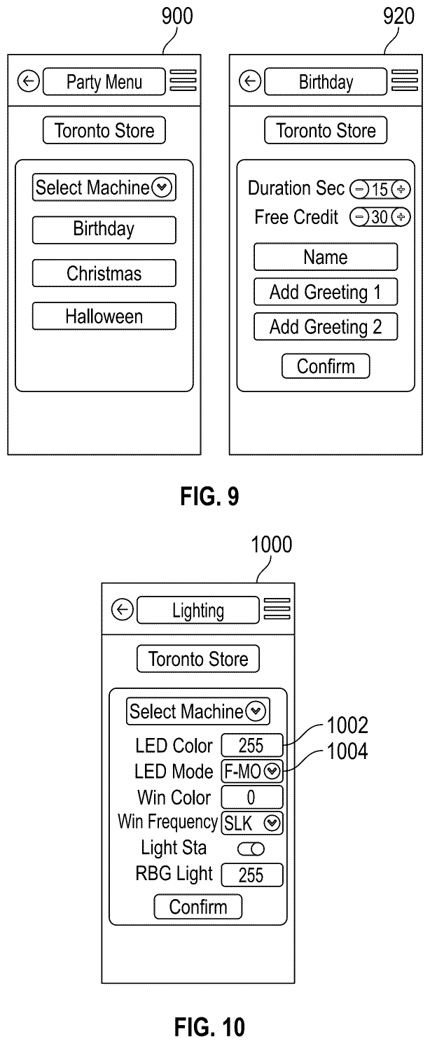

FIG. 9 illustrates an exemplary embodiment 900 of the Party Menu setting screen. This screen comprises a Dropbox for selecting a specific machine whose Party settings are being set. The screen further comprises a button for setting a Birthday event, a button for setting a Christmas event, and a button for setting a Halloween event. More buttons can be added for additional events. When the operator presses the Birthday button, a Birthday setting screen 920 is presented. The Birthday screen 920 comprises an increment-decrement counter for setting the duration of the birthday event. The screen 920 further comprises another increment-decrement counter for setting the number of game credits. The screen 920 also comprises three textboxes for entering the birthday person's name and any additional text messages displayed on the LCD.

FIG. 10 illustrates an exemplary embodiment 1000 of the Lighting setting screen. This screen allows the operator to select a specific crane machine to set the settings. The operator can set the color of the ornamental LED strips with the LED color textbox 1002 and the LED mode with the LED Mode selection box 1004. The operator can also set the color and frequency of the Win graphic display with the Win Color textbox and the Win Frequency selection box.

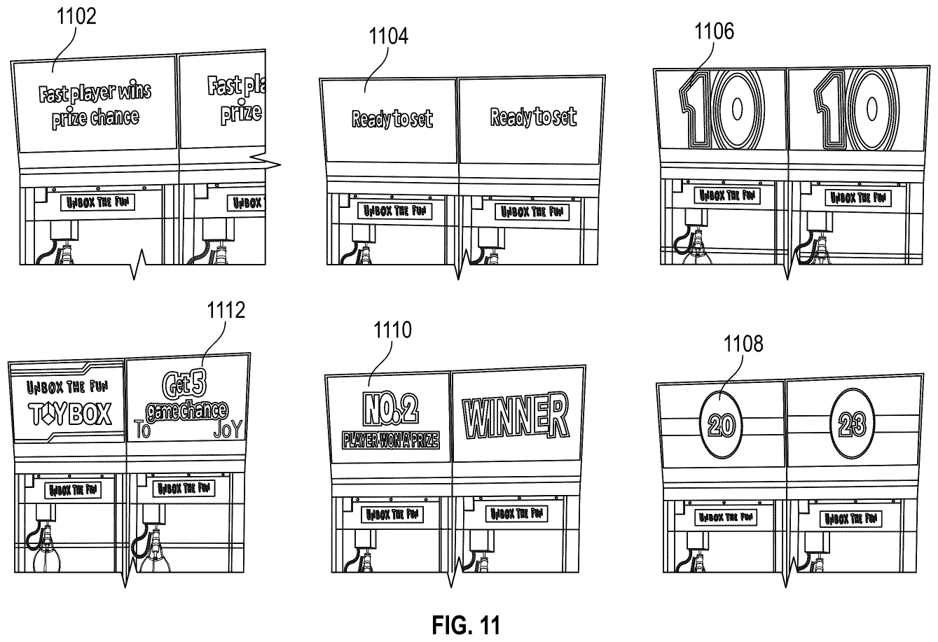

FIG. 11 illustrates many embodiments of the various display options engaged in networked crane machine games. These games can be mini-games and/or tournaments triggered by the number of credits played in a specific group of crane machines or manually by the operator. These mini-games and tournaments are set up to be played on multiple machines within a single location or at multiple different locations so as to become a virtual competition. The settings and mechanics of a specific group of crane machines can be changed at any time before the tournament ends. In one embodiment, these games are set up for a defined duration. In another embodiment, they are set up to run until the game is completed. In one embodiment, the mini-game Tap is set up with an announcement graphic 1102 shown on the overhead LCDs of the group's machines. This Tap game has a set duration and whoever participant taps the most will win. The game then proceeds to display the Ready to Set graphic 1104 to tell the participants to get ready. Then, the game shows a count-down graphic 1106 to count down to the start moment. While the participants are tapping the control button on the control panel, their tap counter 1108 is displayed on the LCD. At the end of the set duration, the winner and his machine number announcement graphic 1110 are announced on the LCD. Seconds after the winner is announced, a prize announcement graphic 1112 is displayed on the LCD. The tournament then concludes.

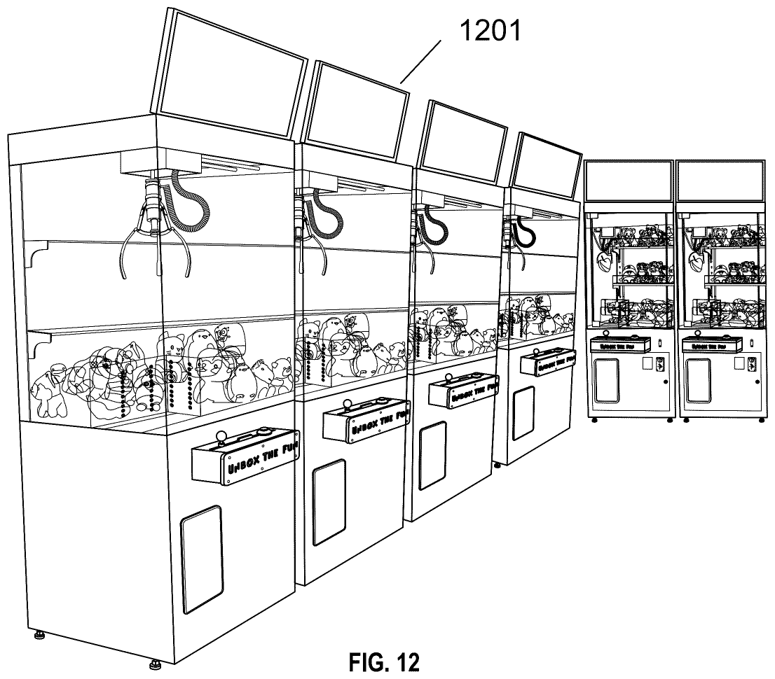

In another embodiment of this invention, a group of machines, at one or multiple locations, can be set up to play a Fastest Claw game where for a set period, participant players will claw a plush as fast as they can. At the end of the tournament, the player with the fastest time wins. In another embodiment of this invention, a Super Claw game can be set up on a group of machines where for a set period, participant players will claw as many prizes as they can. At the end of the tournament, the player with the highest clawed count wins. FIG. 12 illustrates an embodiment where the machines of the present invention are linked together 1201 in the same room for the networking gameplay, as disclosed above.

1. A network crane arcade game system comprising a number of networked arcade crane apparatuses and a number of users wherein said users play one or more network games on said networked arcade crane apparatuses.

2. The system of claim 1, wherein said network game determines a winner among said users based on the highest number of inputs entered by said users.

3. The system of claim 1, wherein said network game determines a winner among said users based on the highest number of inputs entered by said users.

4. The system of claim 1, wherein said network game determines a winner among said users based on the highest number of prizes crane picked by said users.
